(19) United States
(12) Patent Application Publication
(10) Pub. No.: US 2004/0163086 A1
(43) Pub. Date: Aug. 19, 2004

(54) WebDAV servlet

(76) Inventors: Richard Friedman, Cherry Hill, NJ (US); Jason Kinner, Marlton, NJ (US); Joseph J. Snyder, Shamong, NJ (US)

Correspondence Address: HEWLETT-PACKARD COMPANY, Intellectual Property Administration, P.O. Box 272400, Fort Collins, CO, 80527-2400, US

(21) Appl. No.: 10/367,203

(22) Filed: Feb. 14, 2003

(51) Int. Cl. G06F 15/163

(52) U.S. Cl. 719/310

(57) ABSTRACT

Disclosed are WebDAV server components comprising a servlet architecture providing generic interfaces with respect to a plurality of WebDAV methods. Embodiments provide a computer program product comprising code for defining servlets for providing generic interfaces with respect to a plurality of WebDAV methods. Further, embodiments provide a plurality of WebDAV servlets having generic interfaces with respect to a plurality of WebDAV methods, and provide generic interfaces with respect a plurality of HTTP extensions not specifically directed to WebDAV.

### CROSS-REFERENCE TO RELATED APPLICATIONS

The present application is related to co-pending commonly assigned U.S. patent application Ser. No. [Docket Number 100203190-1] entitled “XML DRIVEN WEBDAV UNIT”, U.S. patent application Ser. No. [Docket Number 100202441-1] entitled “WEBDAV URL CONNECTION”, and U.S. patent application Ser. No. [Docket Number 100202438-1] entitled “WEBDAV UNIT TEST FRAMEWORK”, the disclosure of which are hereby incorporated herein in their entirety.

### BACKGROUND

Considerable effort has been expended in order to reduce the time and costs involved with writing, debugging and maintaining software programs. Much of this effort has been related, for example, to developing programming languages and programming techniques which allow programmers to build on or “reuse” programs and code segments that have been written by others. Various other efforts have been directed toward the goal of increasing the efficiency of programmers in developing, modifying, and otherwise maintaining computer programs.

A relatively new approach to software programming called Object-Oriented Design (OOD) or Object-Oriented Programming (OOP) has emerged and has gained increasing popularity among software developers. OOP techniques generally enable increased efficiency in programmers developing, modifying, and maintaining programs because of OOP's emphasis on well-defined and self contained objects. In general, OOP techniques involve the definition, creation, use, and destruction of “objects.” These objects are software entities comprising data elements, attributes, methods, and/or functions, which manipulate the data elements. The attributes and related methods are treated by the software as an entity and can be created, used and destroyed as if they were a single item. Together, the attributes and methods enable objects to model virtually any real-world entity in terms of the entity's characteristics, represented by the data elements, and the entity's behavior, represented by data manipulation functions or methods.

Objects are defined by creating “classes” which are not objects themselves, but which act as templates that instruct the computer how to construct the actual object. A class may, for example, specify the number and type of data variables and the steps involved in the methods which manipulate the object's data. In general, when an object-oriented program is compiled, the class code is compiled into the program, but no objects exist. Therefore, none of the variables or data structures in the compiled program exist or have any memory allotted to them. An object is actually created by the program at runtime by means of a special function called a “constructor” which uses the corresponding class definition and additional information, such as arguments provided during object creation, to construct the object. Likewise, objects can be destroyed by a special function called a “destructor” or can be destroyed by special programs called “garbage collectors” when no longer needed. Objects may be used by using their data and invoking their methods. When an object is created at runtime, memory is allotted and data structures are created.

Examples of OOP languages include C++ and JAVA™, as well as other languages. Each language has an express or implied “object model.” In general, an object model is a unifying set of rules that describe object structure, object life cycle, and inter-object communication. Object structure relates to the physical layout of objects in memory, while object life cycle refers to how applications create and destroy objects. Inter-object communication refers to protocols by which objects communicate with one another. Object models are useful in contexts where all objects in a given system need to conform to a given protocol governing these parameters. Most object-oriented and object-based languages, including the JAVA programming language, do not specify true object models, but merely specify syntax and semantics of a basic object implementation without specifying the actual rules that unify object systems. Some object-oriented languages also incorporate the notion of “components” which are self-contained objects that perform a specified function or procedure. Components have a pre-defined interface that conforms to the object model of the underlying language and generally conform to a “component model” associated with the language.

With the proliferation of the Internet, and more particularly the World Wide Web (Web), having cross-platform (or platform independent) interoperability has become of significant importance in software applications. For instance, a wide variety of platform configurations are used to access commonly-available information (e.g., software applications) on the Internet and the Web. Some Web applications are designed using languages designed specifically for the Web, such as hyper-text mark-up language (HTML) as a way to provide a static, but commonly useable, form of coded information. However, because of the desire to add dynamic capability to Web applications, OOP techniques that are platform independent, such as JAVA, have become very popular.

Further, programmers often desire to share code over a distributed system. A distributed system is one in which there are typically multiple computer systems accessing or sharing information among one another. Client-server systems, for example, are distributed computer systems. These various systems may use a variety of persistent stores, e.g. Open Database Connectivity (ODBC), JAVA Database Connectivity (JDBC), and flat-file, and directory services, e.g. Lightweight Directory Access Protocol (LDAP) and Uniform Resource Locator (URL). This variation in systems causes incompatibilities and inefficiencies in sharing code. Oftentimes, programmers will have to modify code received from others in order to make it re-useable. This additional work tends to decrease code reuse and/or decrease the efficiency of doing so.

The JAVA programming language is rapidly emerging as the preferred OOP language for much application development, including Internet, Web, and other cross-platform applications. While JAVA is a well-known programming language, a brief overview of general principles of JAVA is provided below to aid the reader in better understanding some of the specific examples provided herein that relate to JAVA. In addition to the overview provided herein, further information about JAVA can be found in a plethora of publications, including those available from SUN® MICROSYSTEMS at http://java.sun.com.

In general, JAVA programs consist of bytecodes, which are architecture and operating system independent and can be sent over the Internet and other networks. The bytecode is actually executed on a particular platform by means of a “virtual machine” (VM) which allows a JAVA program to be run on any platform, regardless of whether the JAVA program was developed on, or for, the particular platform which attempts to run the JAVA program. JAVA bytecodes which arrive at the executing machine are interpreted and executed by the embedded VM.

Virtual machine (VM) is a term used to describe software that acts as an interface between compiled JAVA binary code and the microprocessor (or “hardware platform”) that actually performs the program's instructions. Once a JAVA VM has been provided for a platform, any JAVA program (which, after compilation, is called bytecode) can run on that platform. JAVA was designed to allow application programs to be built that could be run on any platform without having to be rewritten or recompiled by the programmer for each separate platform (i.e., is platform independent). JAVA's VM makes this possible.

A complete JAVA program is known as an application, while a segment of JAVA code, which does not amount to a full application, but is reusable, is referred to as an “applet” on the client side and a “servlet” on the server side. JAVA also includes a component model. A component within JAVA is referred to as a “bean,” and includes a defined interface.

In certain situations within object-oriented programming, a plurality of classes may be combined to form an “aggregate component”, and a configuration file (or descriptor) may be associated with such aggregate component to identify the classes that it contains. For example, in JAVA, an Enterprise JAVA Bean (“EJB”) is such an aggregate component, and a configuration file, typically called a “deployment descriptor”, is associated with such EJB to identify the classes that are contained in the EJB, as described further below. Enterprise JAVA Beans is roughly equivalent to Microsoft's Component Object Model/Distributed Component Object Model architecture, but, like all JAVA-based architectures, programs can be deployed across all major operating systems, not just Windows™. EJB's program components are generally known as servlets. The application or container that runs the servlets is sometimes called an application server. An example use of servlets is to replace Web programs that use the common gateway interface (CGI) and a Practical Extraction and Reporting Language script. Another example use is to provide an interface between Web users and a legacy application mainframe application and its database.

Servlets typically run inside multi-threaded servers. Accordingly, servlets are written to handle multiple service requests simultaneously. It, therefore, is the servlet writer's responsibility to synchronize access to any shared resources. Such resources include in-memory data such as instance or class variables of the servlet, as well as external components such as files, database and network connections.

A public abstract class has been developed to simplify writing HTTP servlets. Specifically, the public abstract class “HttpServlet” extends the “GenericServlet” base class and provides a framework for handling the HTTP protocol. Because it is an abstract class, servlet writers must subclass it and override at least one method. The methods normally overridden by the HttpServlet abstract class include doGet, if HTTP GET requests are supported. Overriding the doGet method automatically also provides support for the HEAD and conditional GET operations. Where practical, the getLastModified method should also be overridden, to facilitate caching the HTTP response data. This improves performance by enabling smarter conditional GET support. Additionally, the method doPost is normally overridden, if HTTP POST requests are supported. Similarly, the method doPut is normally overridden, if HTTP PUT requests are supported. The method doDelete is normally overridden by the HttpServlet abstract class, if HTTP DELETE requests are supported. The lifecycle methods init and destroy may be overridden if the servlet writer needs to manage resources that are held for the lifetime of the servlet. However, servlets that do not manage resources do not need to specialize these methods. Finally, the method getServletInfo is normally overridden by the HttpServlet abstract class, to provide descriptive information through a service's administrative interfaces.

It should be appreciated that the service method is not typically overridden by the HttpServlet abstract class. The service method, as provided, supports standard HTTP requests by dispatching them to appropriate methods, such as the methods listed above that have the prefix “do”. In addition, the service method also supports the HTTP 1.1 protocol's TRACE and OPTIONS methods by dispatching to the doTrace and doOptions methods. The doTrace and doOptions methods are not typically overridden.

The World Wide Web Distributed Authoring and Versioning (WebDAV) standard defined by the Internet Engineering Task Force (IETF) extends HTTP to provide a standard infrastructure for asynchronous collaborative authoring across the Internet. The WebDAV extensions support the use of HTTP for interoperable publishing of a variety of content, providing a common interface to may types of repositories and making the Web analogous to a large-grain, network-accessible file system. The WebDAV set of extensions to HTTP generally provide for up to six capabilities, those being overwrite prevention, properties, name-space management, version management, advanced collections, and access control.

There have typically been three general mechanisms available for adding functionality to HTTP, such as to provide the aforementioned WebDAV extensions, those being URL “munging,” RPC-via-POST, and adding new methods. URL munging is a technique whereby a command is appended to the end of a URL, typically after a “?”. Although URL munging has the advantage of being easily parsed by a CGI script, it suffers from disadvantages such as the potential for interaction between two extensions using the same URL munging convention and the assumption that HTTP GET is the only method used to retrieve Web contents. Using HTTP-via-POST, a client marshals parameters into an HTTP message body, along with an identifier for the function to be performed, and then sends the message body to the server using the HTTP POST method. Although RPC-via-POST is easily mapped onto existing mechanism for extending HTTP servers such as CGI etcetera, its use presents security holes through which almost any operation can be executed. Extending HTTP by creating a new HTTP method has the advantage of using the designed-in mechanism for extending HTTP, which can therefore take advantage of existing features such as operation precondition headers such as “If-[None-]Match.” Moreover, operation-based security and access control is relatively easy since the operation always occurs at a predictable location in the protocol stream.

### SUMMARY

Embodiments provide a WebDAV server component comprising a servlet architecture providing generic interfaces with respect to a plurality of WebDAV methods.

Embodiments additionally provide a computer program product comprising code for defining servlets for providing generic interfaces with respect to a plurality of WebDAV methods.

Further, embodiments provide a WebDAV system comprising means for providing a plurality of WebDAV servlets having generic interfaces with respect to a plurality of WebDAV methods, and means for providing generic interfaces with respect a plurality of HTTP extensions not specifically directed to WebDAV.

### BRIEF DESCRIPTION OF THE DRAWINGS

FIG. 1 shows a server adapted according to the teachings of an embodiment; and

FIG. 2 shows a block diagram of a computer system which is adapted to use embodiments described herein.

### DETAILED DESCRIPTION

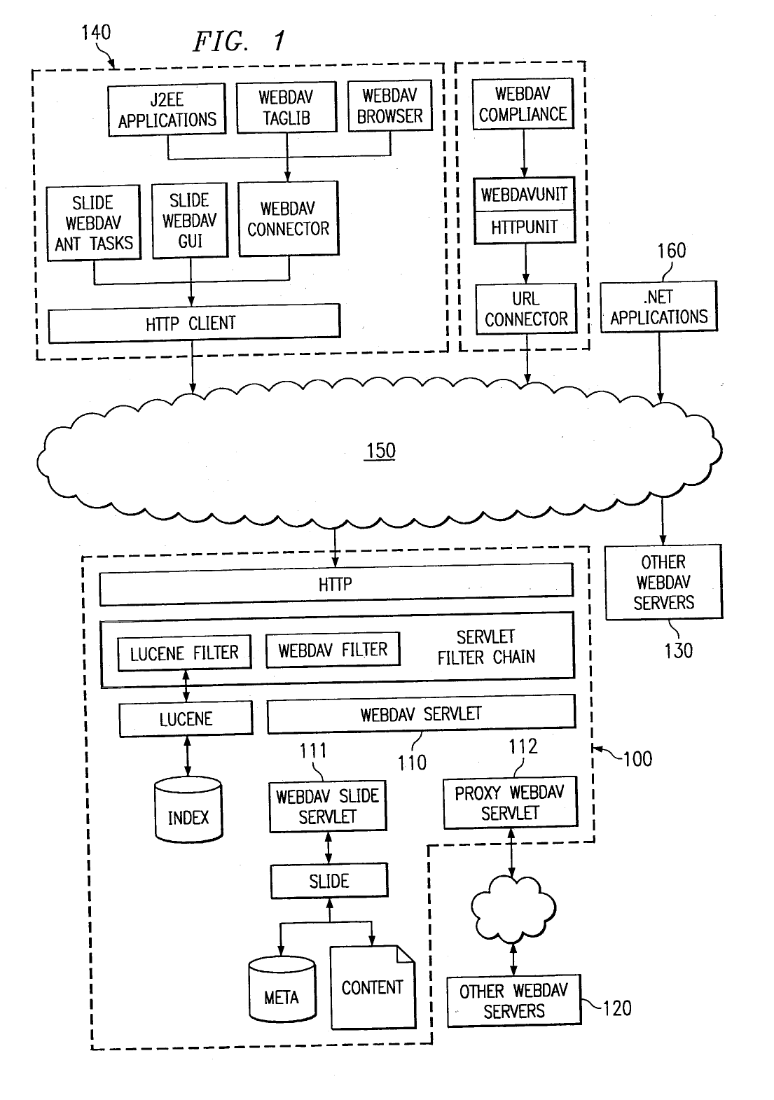

Embodiments provide generic interfaces to facilitate WebDAV developers extending any WebDAV server. For example, directing attention to FIG. 1, middleware components may be provided or adapted according to embodiments to include generic interfaces and/or utilities as WebDAV Servlet 110. WebDAV Servlet 110 of FIG. 1 is operable upon server 100. Also shown in FIG. 1 for completeness is client system 140 coupled to server 100 via network 150. Of course, systems other than client system 140 may be in communication with server 100, in particular implementations, such as other servers 120 and 130, .NET applications 160, and/or the like.

WebDAV Servlet 110 of an embodiment provides a simple interface allowing servlet developers to extend any WebDAV server, e.g., server 100, to create proxies to single or aggregate WebDAV servers, and/or create custom decisions based on request information. For example, a WebDAV Servlet implementation of one embodiment may be utilized to provide WebDAV Slide Servlet 111, such as may implement Apache's Slide content management system as a WebDAV Servlet. Additionally or alternatively, a WebDAV Servlet implementation of embodiments may be utilized to provide Proxy WebDAV Servlet 112 to create proxies to WebDAV Servers 120.

According to one embodiment, WebDAV Servlet 110 is similar in concept to the existing HTTP servlet interface developers have become accustomed to. Additionally or alternatively, WebDAV Servlet 110 of an embodiment may provide direct integration for custom processing of WebDAV requests. For example, a WebDAV Servlet for implementing the aforementioned Slide content may provide direct integration into Slide to accommodate custom processing of the appropriate WebDAV requests.

An embodiment architecture for the WebDAV servlet of one embodiment provides for processing of WebDAV requests by extending the javax.servlet.http.HttpServlet class. For example, WebDAV Servlet 110 may provide one method for each of the WebDAV methods defined in the WebDAV specification. According to one embodiment, each of these methods is named do[WebDAVMethod], where [WebDAVMethod] is the WebDAV request method being implemented. Accordingly, in addition to the standard doGet, doPost, doPut, and doDelete of the HttpServlet class, the following methods may be defined by WebDAV Servlet 110 of one embodiment: doPropFind, doPropPatch, doMkCol, doCopy, doMove, doLock, and doUnLock.

According to embodiments, when a particular WebDAV servlet is executed, the underlying servlet container calls the servlet's service method. The WebDAV servlet's service method may determine the method of the request and, using the command pattern, call the appropriate method. The servlet may be defined as abstract with each method returning the HTTP status SC_METHOD_NOT_ALLOWED (405). An exception to the foregoing may be the doOptions method which has been implemented to check for the implementation of any of the methods in servlets that extend the WebDAV servlet.

Using WebDAV Servlet 110 of an embodiment implements a class to override one or more methods for servicing WebDAV requests. WebDAV defines multiple levels of compliance that can be reported to a client, those being levels 1 and 2. For level 1 compliance, a WebDAV servlet may implement all methods except for the doLock and doUnLock methods. For level 2 compliance, the WebDAV servlet may implement all methods in the WebDAV servlet abstract class. According to embodiments, WebDAV servlets report their own level of compliance through an overridable method, getComplianceLevel, which returns a string representing the compliance level to report to the client. Constants may be defined in the base class to provide an easier programming environment.

According to embodiments, WebDAV Servlet 110 is configured as any other servlet is configured. There are, however, special considerations for security. Because WebDAV defines additional HTTP methods, embodiments ensure that these methods are secured in an appropriate way in the web application deployment descriptor (e.g., WEB-INF/web.xml).

When implemented in software, the elements of one embodiment comprise essentially the code segments to perform the necessary tasks. The program or code segments can be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

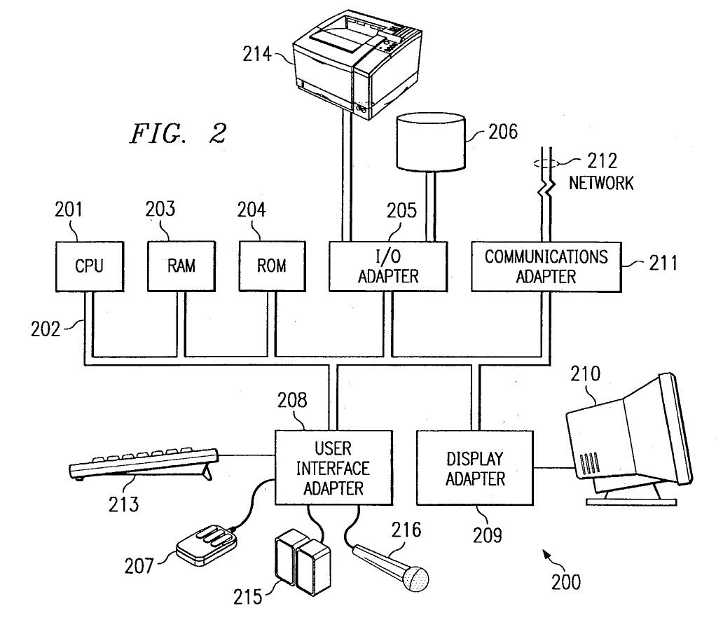

FIG. 2 illustrates computer system 200, such as may correspond to server 100 of FIG. 1, adapted according to one embodiment. Central processing unit (CPU) 201 is coupled to system bus 202. The CPU 201 may be any general purpose CPU, such as an HP PA-8500 or Intel Pentium processor. However, application of the teachings and concepts herein is not restricted by the architecture of CPU 201 as long as CPU 201 supports the inventive operations as described herein. Bus 202 is coupled to random access memory (RAM) 203, which may be SRAM, DRAM, or SDRAM. ROM 204 is also coupled to bus 202, which may be PROM, EPROM, or EEPROM. RAM 203 and ROM 204 hold user and system data and programs as is well known in the art.

Bus 202 is also coupled to input/output (I/O) controller adapter 205, communications adapter 211, user interface adapter 208, and display adapter 209. The I/O adapter 205 connects to storage devices 206, such as one or more of a hard drive, a CD drive, a floppy disk drive, a tape drive, to the computer system. The I/O adapter 205 is also connected to printer 214, which would allow the system to print paper copies of information such as document, photographs, articles, etc. Note that the printer may be a printer (e.g. dot matrix, laser, etc.), a fax machine, or a copier machine. Communications card 211 is adapted to couple the computer system 200 to a network 212, such as may correspond to network 150 of FIG. 1, which may comprise one or more of a telephone network, a local area network (LAN), a metropolitan area network (MAN), a wide-area (WAN) network, a wireless network, an Ethernet network, the Internet, and/or the like. User interface adapter 208 couples user input devices, such as keyboard 213, pointing device 207, and microphone 216, to the computer system 200. User interface adapter 208 also provides sound output to a user via speaker(s) 215. The display card 209 is driven by CPU 201 to control the display on display device 210.

What is claimed is:

1. A WebDAV server component comprising:
a servlet architecture providing generic interfaces with respect to a plurality of WebDAV methods.

2. The WebDAV server component of claim 1, wherein said WebDAV methods comprise doPropFind, doPropPatch, doMkCol, doCopy, doMove, doLock, and doUnLock.

3. The WebDAV server component of claim 2, wherein said servlet architecture further provides generic interfaces with respect a plurality of HTTP extensions not specifically directed to WebDAV.

4. The WebDAV server component of claim 3, wherein said HTTP extensions comprise doGet, doPost, doPut, and doDelete.

5. The WebDAV server component of claim 1, wherein said servlet architecture implements a class to override at least one method for servicing WebDAV requests.

6. The WebDAV server component of claim 1, wherein said servlet architecture is utilized to provide a WebDAV Slide Servlet, to implement a predefined content management system as a WebDAV Servlet.

7. The WebDAV server component of claim 1, wherein said servlet architecture is utilized to provide a Proxy WebDAV Servlet to create a proxy to at least one other WebDAV server.

8. A computer program product comprising:
code for defining servlets for providing generic interfaces with respect to a plurality of WebDAV methods.

9. The computer program product of claim 8, wherein said WebDAV methods comprise doPropFind, doPropPatch, doMkCol, doCopy, doMove, doLock, and doUnLock.

10. The computer program product of claim 9, wherein said code for defining servlets further provides for generic interfaces with respect a plurality of HTTP extensions not specifically directed to WebDAV.

11. The computer program product of claim 10, wherein said HTTP extensions comprise doGet, doPost, doPut, and doDelete.

12. The computer program product of claim 8, wherein said code for defining servlets implements a class to override at least one method for servicing WebDAV requests.

13. The computer program product of claim 8, wherein said code for defining servlets is utilized to provide a WebDAV Slide Servlet, to implement a predefined content management system as a WebDAV Servlet.

14. The computer program product of claim 8, wherein said code for defining servlets is utilized to provide a Proxy WebDAV Servlet to create a proxy to at least one other WebDAV server.

15. The computer program product of claim 8, wherein said code for defining servlets comprises a WebDAV middleware server component.

16. A WebDAV system comprising:
means for providing a plurality of WebDAV servlets having generic interfaces with respect to a plurality of WebDAV methods; and
means for providing generic interfaces with respect a plurality of HTTP extensions not specifically directed to WebDAV.

17. The system of claim 16, wherein said WebDAV methods comprise doPropFind, doPropPatch, doMkCol, doCopy, doMove, doLock, and doUnLock.

18. The system of claim 16, wherein said HTTP extensions comprise doGet, doPost, doPut, and doDelete.

19. The system of claim 16, further comprising:
means for overriding at least one method for servicing WebDAV requests.

20. The system of claim 16, further comprising:
means for an underlying servlet container calling a servlet's service method when a particular WebDAV servlet of said plurality of WebDAV servlets is executed.
